(19) United States
(12) Patent Application Publication
(10) Pub. No.: US 2002/0115329 A1
(43) Pub. Date: Aug. 22, 2002

(54) Automotive integrated power module system (AIPM)

(76) Inventors: Edwin Collin, Southington, CT (US); William D. Porzio, Woodbury, CT (US); Allen J. Bernardini, Southbury, CT (US)

Correspondence Address: LOWE HAUPTMAN GILMAN & BERNER, LLP, 1700 Diagonal Road, Suite 310, Alexandria, VA, 22314, US

(21) Appl. No.: 10/073,056

(22) Filed: Feb. 12, 2002

Related U.S. Application Data
(60) Provisional application No. 60/267,699, filed on Feb. 12, 2001.

(51) Int. Cl. H01R 13/52

(52) U.S. Cl. 439/275

(57) ABSTRACT

The present invention is directed to an automotive integrated power module system in which an electrical connector can be connected to a converter having integral contacts. The contacts which are connected to shielded cable, are sealed from the environment. The present invention provides an electrical connector for connection to a converter having integral contacts.

### RELATED APPLICATION

The present application claims priority from U.S. Provisional Patent Application Serial No. 60/267,699, entitled “AIPM (Automotive Integrated Power Module) POWER CONNECTOR SYSTEM”, filed on Feb. 12, 2001 which is hereby referenced in its entirety into this specification.

### FIELD OF THE INVENTION

The present invention relates generally to the field of electrical connectors, and more particularly, to electrical power connectors. More particularly, the present invention relates to automotive power connection systems.

### BACKGROUND OF THE INVENTION

Inverters and converters used in automotive power systems typically use terminal threaded type connectors for incoming AC power and outgoing DC power. The difficulty with such connectors is that there are significant forces required to connect the connector, the connections are not environmentally sealed and the time for assembly is relatively long. Some converters now have integral electrical contacts. Accordingly, a need exists in the art for a connector and system which substantially overcomes these disadvantages and which can be connected to an inverter having integral electrical contacts.

### SUMMARY OF THE INVENTION

It is, therefore, an object of the present invention to provide an electrical connector for an automotive application which is sealed from the environment.

Another object of the present invention is to provide an electrical connector which can be easily connected to a converter having integral electrical contacts.

The present invention is directed to an automotive integrated power module system in which an electrical connector can be connected to a converter having integral contacts. Advantageously, the contacts which are connected to shielded cable, are sealed from the environment. Also advantageously, the present invention provides an electrical connector for connection to a converter having integral contacts.

These and other objects of the present invention are achieved by an electrical connector including a housing that has a plurality of through holes for receiving a corresponding electrical cable and has an input end and an output end. One of the plurality of contacts extends beyond the output end. A plurality of contacts is positioned in a respective through hole and a plurality of ferrules seals an input end of the through holes and a seal for sealing the housing to a mating electrical device.

The foregoing and other objects of the present invention are achieved by an electrical connector that receives and mates to an inverter housing and has a plurality of contacts extending therefrom. A housing has a plurality of through holes for receiving a corresponding electrical cable and has an input end and an output end, one of the plurality of contacts extends beyond the output end. A plurality of contacts is positioned in a respective through hole and a plurality of ferrules seals an input end of the through holes and a seal for sealing the housing to the converter.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 is an exploded perspective view of an electrical connector according to a first embodiment of the present invention;

FIG. 2 is a contact blade connector used in the FIG. 1 electrical connector;

FIG. 3 is a perspective view of the electrical connector omitting the wall of the plug connector;

FIG. 4 is a perspective view of the electrical connector of the present invention attached to an inverter box assembly;

FIG. 5 is an inverter box including pin contacts usable with a second embodiment of the electrical connector according to the present invention;

FIG. 6 is an exploded perspective view of an electrical connector usable with the inverter box depicted in FIG. 5; and

FIG. 7 is a perspective view of a plug cover depicted in FIG. 6.

### DETAILED DESCRIPTION OF THE INVENTION

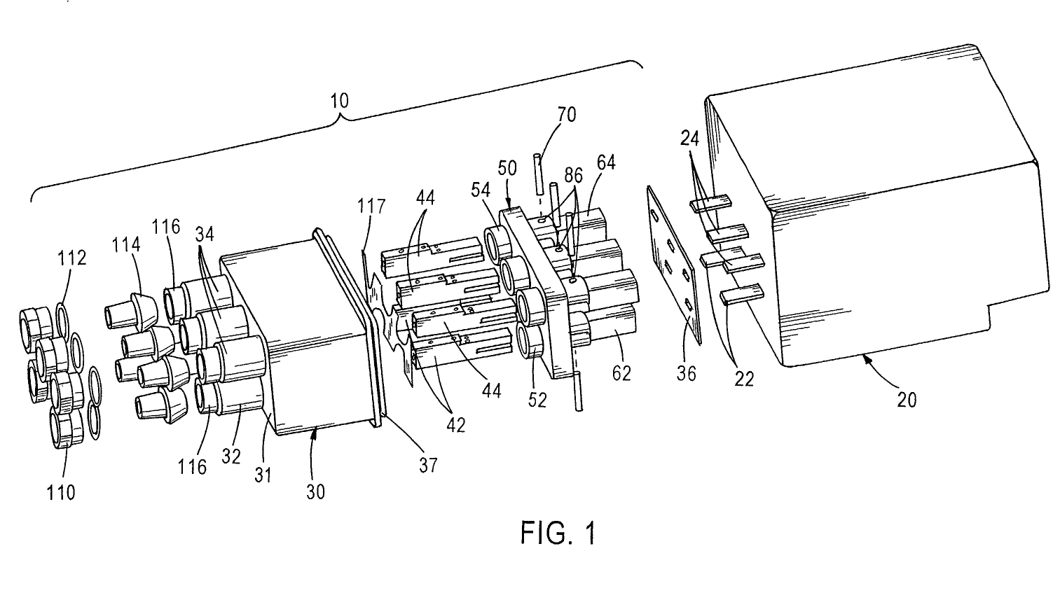

An electrical connector 10 according to a first embodiment of the present invention is depicted in FIG. 1. The electrical connector 10 mates with an inverter 20 having two power input contact blades 22 for input DC power and three power output blades 24 for outgoing AC current. The connector 10 can have fewer contacts than shown and all of the contacts can be used as outputs, all can be used as inputs, or any combination of the two. The inverter 20 can also be a converter. A gasket can be mounted either to the electrical connector 10 or to the inverter 20. The inverter 20 is typically supplied by the customer. The electrical connector 10 includes a plug body 30 having a generally rectangular shape and a hollow interior.

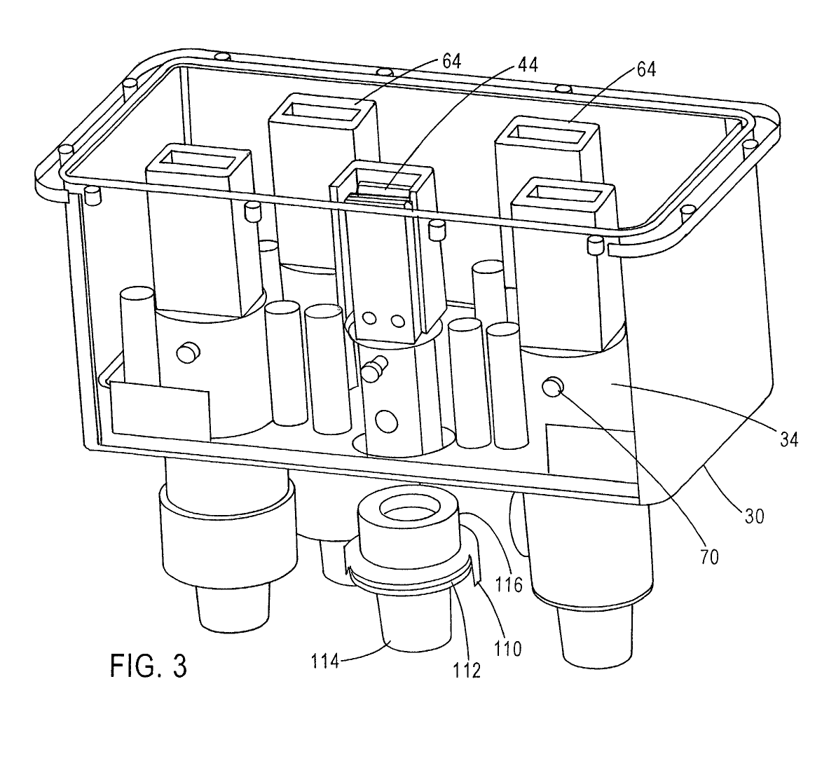

As depicted in FIGS. 1 and 3, five circular bosses 32, 34 extend through one wall 31 of the plug body 30. These circular bosses 32, 34 are used to hold five blade contacts 44, 42. The contacts 44 are positioned within the bosses 34 and the contacts 42 are positioned within the bosses 32. An electrically non-conductive contact insulator 50 has a rectangular central section, a plurality of round bosses 52, 54 on one side to mate with corresponding round bosses 42, 44, respectively, in the plug body 30. Hollow rectangular bosses 62, 64 extend from an opposite side of the contact retainer and are aligned with circular bosses 52, 54, respectively. A plurality of shielded cables (not shown) are attached to each of corresponding one of the contacts 42, 44. A seal 36 seals a front face 37 of the plug body 30 to a front face of the inverter 20.

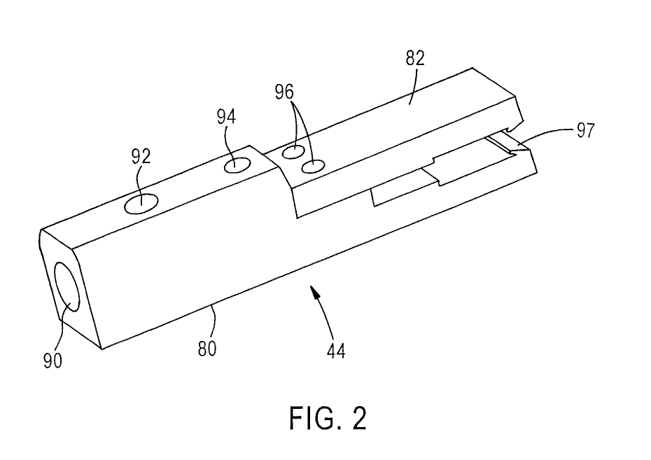

Referring now to FIG. 2, the braiding and shielding are stripped back from the cable (not shown) and the end of the stripped cable is inserted into hole 90 (see FIG. 2 in the contact 42 or 44). The stripped end is held in place using a fastener inserted into hole 92 which are transverse to the longitudinal axis of the contact 44. The nut 110, washer 112, grommet 114 and compression ring 116 hold the braided cable in place and form a seal to the plug body 30. The contact 44 is fabricated in two pieces 80 and 82 which together form a slot 96 for receiving a respective bladed contact 22, 24.

Returning to FIG. 1, the contact 42, 44 is retained by insulator 50 using a retention pin 70 which is inserted through a hole 86 in the bosses 62, 64. The shielded and braided portion of the cable is retained using thread nuts 110 and washers 112, an elastomer grommet 114 and a metallic ring 116. A seal 117 is a back seal for sealing the contacts 44 to the plug body 30 and also serves as an insulator. The seal 117 is located between the plug body 30 and the insulator 50 for sealing the screw (not shown) which mounts the plug body 30 to insulator 50.

Another feature is to provide EMI protection by terminating individual conductor cable shielding directly to the plug body 30 and then directly to the inverter 20 with a minimum number of connection joints. Also, an additional contact can be supplied to attach the cable shields of the conductors to a system ground. Also, one of the contacts can be connected to ground.

Advantageously, the combination of elastomer grommets 114 and seal 36 provide a hermetic environment for the junction of the shielded cable and between the contacts 42, 44 and the contacts 22, 24, respectively. The seal 37 seals the plug body 30 to the inverter 20 and the grommet 114 seals the cable (not shown) to the plug body 30.

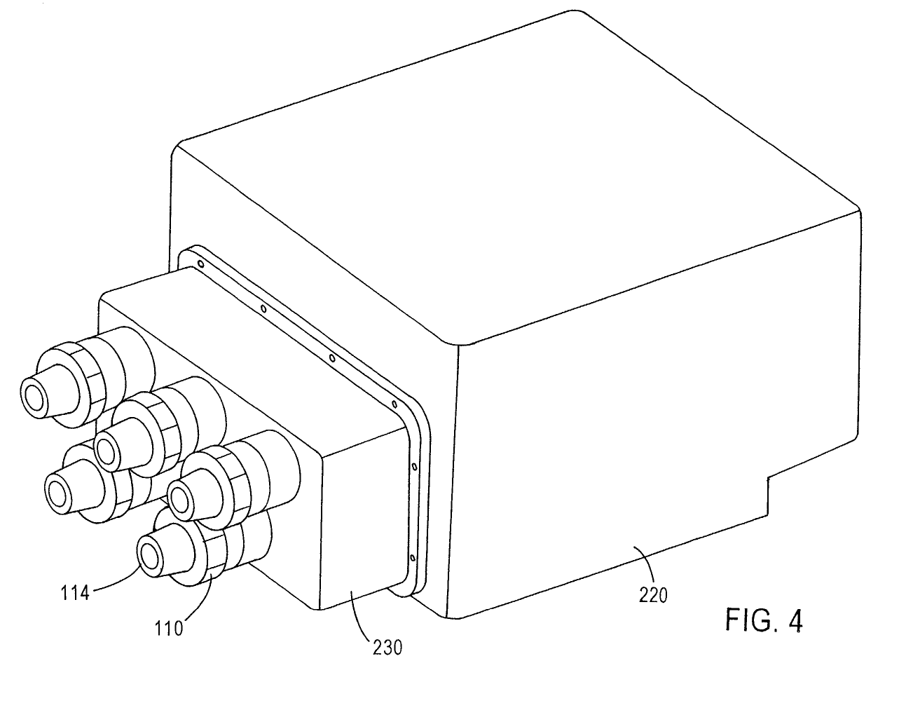

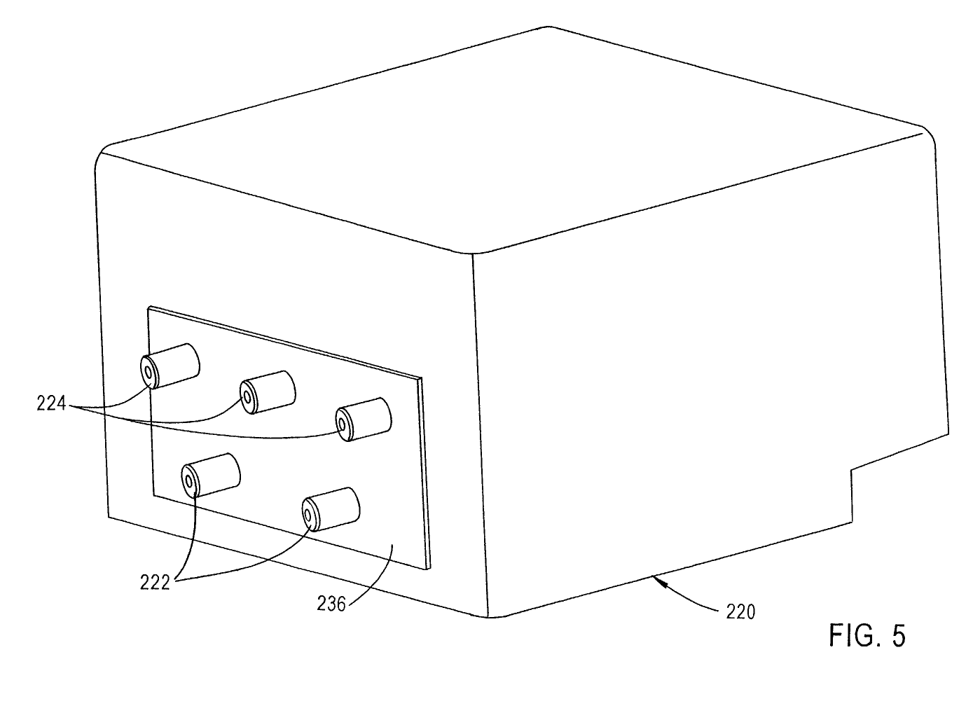

Referring now to FIG. 4, a second embodiment of the present invention is depicted in which the inverter box 220 has circular pin type contacts 222, 224 (see FIG. 5) instead of the blade type contacts depicted with respect to the first embodiment. In all other respects, the second embodiment is identical to the first embodiment. All of the elements that are different in the second embodiment are numbered with a 200 series reference number and all of the elements which are identical have the same reference numbers.

As depicted in FIG. 5, the converter box has three output AC power contacts 224 and two input power contacts 222.

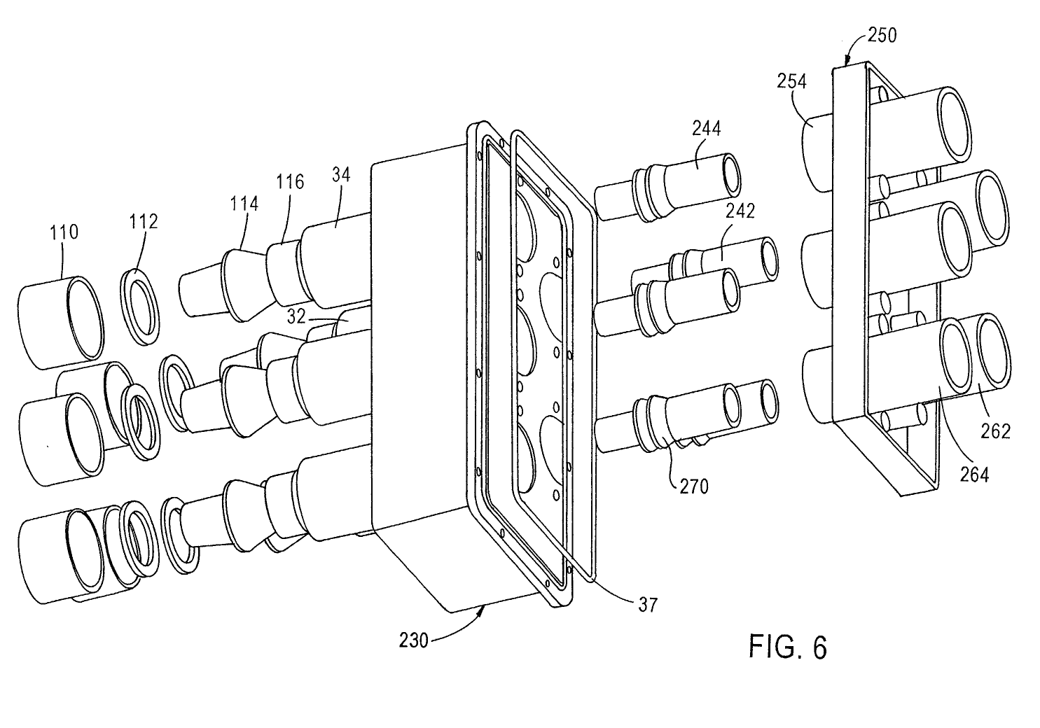

As depicted in FIG. 6, a plug body 230 can be sealed to the converter 220 using a gasket 37 on the front face thereof. A plurality of hollow cylindrical contacts 242, 244 are positioned within insulator 250 using retention clips 270. The insulator 250 has a plurality of bosses 254 which were aligned with bosses 34 in the plug body. A plurality of bosses 262, 264 are also aligned with bosses 32, 34 in the plug body 30. Bosses 262, 264 extend forwardly in a direction towards the inverter 220. Bosses 254, 252 are aligned with bosses 262, 264, respectively and extend rearwardly in a direction towards bosses 32, 34, respectively. The cables are connected to the contacts 242, 244 by crimping or compression screws or the like.

The shield on each of the cables is stripped and attached to the plug body 30 as discussed previously. The clip retention rings 270 are included on each of the contacts 242, 244 in the insulator 250. Seal 37 provides a hermetic seal between the plug body and the inverter 220.

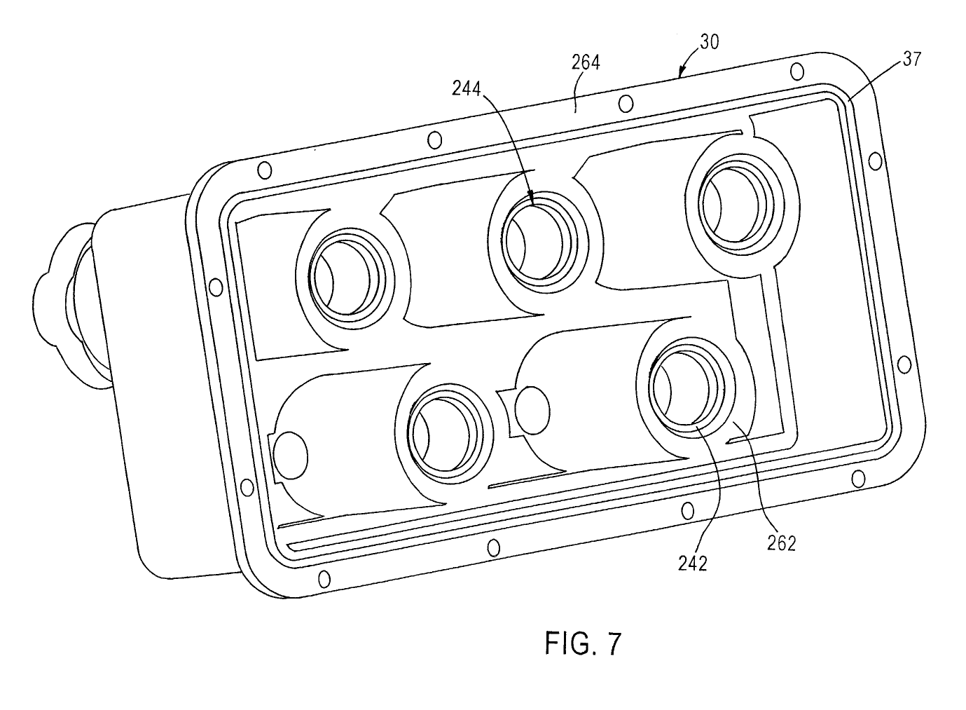

FIG. 7 depicts the contacts 242, 244 positioned within respective bosses 262, 264.

It will be readily seen by one of ordinary skill in the art that the present invention fulfills all of the objects set forth above. After reading the foregoing specification, one of ordinary skill will be able to affect various changes, substitutions of equivalents and various other aspects of the invention as broadly disclosed herein. It is therefore intended that the protection granted hereon be limited only by the definition contained in the appended claims and equivalents thereof.

What is claimed is:

1. An electrical power connector, comprising:
a housing having a plurality of through holes each for receiving a corresponding electrical cable and each having an input end and an output end, one of the plurality of contacts extending beyond said output end;
a plurality of contacts positioned in a respective through hole;
a plurality of ferrules each for sealing an input end of said through holes; and
a seal for sealing said housing to a mating electrical device.

2. The electrical power connector of claim 1, further comprising a contact holder for retaining each of said plurality of contacts.

3. The electrical power connector of claim 1, wherein each of said contacts is a blade-type contact.

4. The electrical power connector of claim 3, wherein each of said blade type contacts has a two-piece construction.

5. The electrical power connector of claim 1, wherein said seal is a gasket type seal.

6. The electrical power connector of claim 1, wherein said contacts are arranged to receive pin-type contacts.

7. The electrical power of claim 1, wherein said electrical device is an inverter.

8. The electrical power of claim 1, wherein some of said contacts carry DC current and some of said contacts carry AC current.

9. The electrical power of claim 1, wherein said connector is an automotive type connector.

10. An electrical connector for receiving and mating to a converter housing having a plurality of contacts extending therefrom, comprising:
a housing having a plurality of through holes each for receiving a corresponding electrical cable and each having an input end and an output end, one of the plurality of contacts extending beyond said output end;
a plurality of contacts positioned in a respective through hole;
a plurality of ferrules each for sealing an input end of said through holes; and
a seal for sealing said housing to said converter.

11. The electrical power connector of claim 10, further comprising a contact holder for retaining each of said plurality of contacts.

12. The electrical power connector of claim 10, wherein each of said contacts is a blade-type contact.

13. The electrical power connector of claim 12, wherein each of said blade type contacts has a two piece construction.

14. The electrical power connector of claim 10, wherein said seal is a gasket type seal.

15. The electrical power connector of claim 10, wherein said contacts are arranged to receive pin-type contacts.

16. The electrical power of claim 10, wherein some of said contacts carry DC current and some of said contacts carry AC current.

17. The electrical power of claim 10, wherein said connector is an automotive type connector.
